(19) United States
(12) Patent Application Publication
(10) Pub. No.: US 2011/0304645 A1
(43) Pub. Date: Dec. 15, 2011

(54) TECHNIQUES FOR PROVIDING HOLISTIC VIEWS OF PERSONAL ENERGY CONSUMPTION

(76) Inventors: MILAN MILENKOVIC, PORTLAND, OR (US); MARK M. CHANG, SARATOGA, CA (US); ULF R. HANEBUTTE, GIG HARBOR, WA (US); SCOTT E. SHULL, HILLSBORO, OR (US)

(21) Appl. No.: 13/174,159

(22) Filed: Jun. 30, 2011

(51) Int. Cl. G06F 17/00

(52) U.S. Cl. 345/619; 345/418

(57) ABSTRACT

Techniques for providing holistic views of energy consumption. Energy consumption of one or more energy consuming devices corresponding to a user is monitored. The energy consumption for the one or more energy consuming devices is aggregated. A graphical representation of the energy consumption is provided to the user for the one or more energy consuming devices and aggregate energy consumption. The graphical representation comprises at least one visual metaphor for energy consumption.

### TECHNICAL FIELD

Embodiments of the invention relate to techniques for determining energy usage. More particularly, embodiments of the invention relate to techniques for providing user feedback regarding personal energy consumption.

### BACKGROUND

Tracking energy usage is increasingly important in many settings. For example, many regulations require that commercial buildings conform to certain energy efficiency requirements. In order to monitor compliance, energy usage must be measured in some way. Typical measurement techniques are based on dedicated hardware monitors, which can be expensive and complex.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a block diagram of one embodiment of an architecture for monitoring energy consumption.

FIG. 2 is one embodiment of a graphical interface for presenting individual energy consumption.

FIG. 3 is a second embodiment of a graphical interface for presenting individual energy consumption.

FIG. 4 is a flow diagram of one embodiment of a technique for monitoring and/or presenting individual energy consumption.

FIG. 5 is a block diagram of one embodiment of an electronic system.

### DETAILED DESCRIPTION

In the following description, numerous specific details are set forth. However, embodiments of the invention may be practiced without these specific details. In other instances, well-known circuits, structures and techniques have not been shown in detail in order not to obscure the understanding of this description.

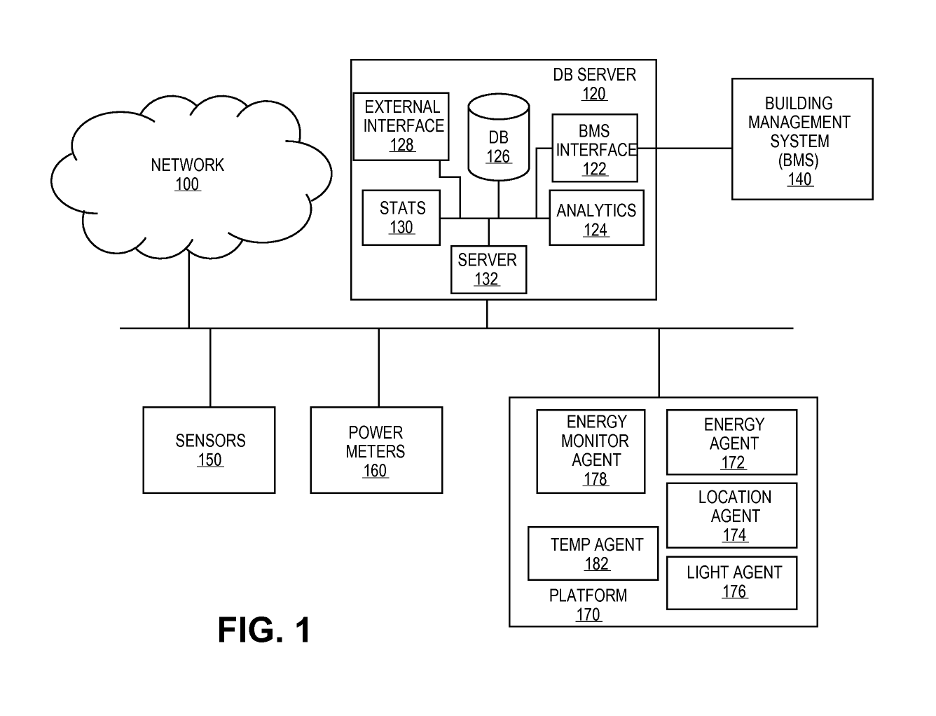

FIG. 1 is a block diagram of one embodiment of an architecture for monitoring energy consumption. The architecture of FIG. 1 allows for a two-way communication between an individual user of a platform and a building infrastructure including a building management system. This may provide for better feedback to a user as well as a better aggregate view of energy consumption.

Network 100 provides an interconnection between multiple electronic devices. Network 100 may provide communication with any number of remote devices not illustrated in FIG. 1. Network 100 may be, for example, the Internet.

Database (DB) server 120 may be coupled with network 100 and other systems. DB server 120 may also be coupled with building management system (BMS) 140 that may include information from, or access to, building systems (e.g., HVAC, electrical, hydraulic, automation) that may provide energy consumption data. DB server 120 may be coupled with BMS 140 via BMS interface 122, which may be one or more wired and/or wireless interfaces.

DB server 120 includes database (DB) 126, which is used to store information retrieved by, sent to, or otherwise acquired by DB server 120. In one embodiment, DB 126 stores energy consumption information gathered from the components illustrated in FIG. 1 as well as any other components. External interface(s) 128 provides one or more wired and/or wireless interfaces between DB server 120 and other sensors or components (not illustrated in FIG. 1).

Statistics 130 may be statistics that are derived by DB server 120 or are provided to DB server 120. Statistics 130 may be used to provide energy consumption information and/or to analyze and derive energy consumption information. Analytics 124 represent logic (e.g., hardware, software, firmware, any combination thereof) that provides analysis of the information stored by DB server 120. For example, analytics 124 may provide macro or micro analysis of energy consumption information as described herein. Server 132 provides services from DB server 120 to devices coupled with DB server 120.

Sensors 150 may be any sensors that provide information to any of the devices of FIG. 1. Sensors 150 may be any type of sensors, for example, temperature sensors, light sensors, wind sensors, etc. Sensors 150 may also include soft sensors, for example, a software agent that provides data in sensor format derived from other forms of data, such as a weather station report. Power meters 160 may be any power meters that provide power information to any of the devices of FIG. 1. Power meters 160 may be any type of power meters that monitor power, for example, at power outlets, light fixtures, or power consumption of any other electrical device.

Platform 170 represents any number of similar platforms that may be coupled with one or more networks interconnected with DB server 120 and/or other devices of FIG. 1. Platform 170 may be, for example, a laptop computer, a desktop computer, or any other device that may be utilized to provide some or all of the information described herein.

In one embodiment, platform 170 includes one or more of the agents illustrated in FIG. 1 in addition to logical and computational components not illustrated in FIG. 1. Energy monitoring agent may 178 provide energy monitoring feedback and functionality to a user of platform 170. Temperature agent 182 may monitor temperature conditions in and/or around platform 170. For example, temperature agent 182 may monitor the ambient temperature of the space in which platform 170 resides, or may monitor the temperature of platform 170.

Energy agent 172 monitors and/or computes, or otherwise determines energy consumption of platform 170. Energy agent 172 may operate as described herein to determine energy consumption. Location agent 174 operates to determine the position of platform 170. Location agent 174 may use global positioning system (GPS) technology, or other techniques for determining the location of platform 170.

Light agent 176 monitors light levels around platform 170. Light agent 176 may include, for example, an ambient light sensor. Light agent 176 may also calculate or otherwise determine light conditions in and around platform 170.

Conceptually, the techniques described herein operate by tracking the time that the monitored system (e.g., platform 170) spends in various operational states—such as running, idle, off—and by multiplying the time spent in each state with platform power drawn in each state to compute energy usage (energy=power×time). In one embodiment, there is provided (1) the ability to detect operational states of the monitored system and times spent in those operational states, and (2) information related to power consumption in each of the relevant operational states of the monitored system.

This principle may be applied to any electronic equipment or device (e.g., HVAC system) that has operational states with specific energy consumption, such as desktop computers or laptops, by providing a software agent to track platform power state occupancy using, for example, system calls, then compute energy usage by integrating over time state occupancy with power consumed in each state, thus yielding energy consumption in KWh. Non-electrical energy consumption can also be monitored, for example, a state of a heating system may be monitored and energy consumption may be determined by using the state of the heating system along with the amount of natural gas consumed in each state to determine an energy usage. This technique is applicable to other situations as well.

The energy-tracking agent(s) may reside on the platform or elsewhere in the infrastructure (e,g, a cloud service or with one device acting as proxy for another-PC for a printer). Currently energy measurement is performed via expensive external hardware power meters.

Described herein are techniques to provide a holistic, visual and/or numeric representation of the amount of energy an individual is consuming across a range of concurrent activities: computing, lighting heating/cooling, local power strip devices, remote charging of an electric vehicle, etc. In one embodiment, a user interface provides a visual metaphor, with accurate numeric values that depict an individual's energy consumption in a stylized but accurate manner so that the individual can monitor and manage their behavior with in a building and at the same time the building can monitor and manage its services to the individual as well as the aggregate population within the building. A two-way dialog among building occupants and the building management system may be supported.

Described herein is a graphical user experience (GUX) that consists of a dynamic visual metaphor (e.g., garden of flowers) that is active in relation to the energy consumption attributed to the user. In one embodiment, the GUX changes visually (e.g., each flower dynamically blooming or wilting) and is annotated with power consumption data related to each of the monitored sinks of energy attributed to the user.

In one embodiment the visual state of the GUX is triggered from a remote sensor database that collects streaming sensor data coming from the user's computing platform that includes the ability to measure, for example, ambient light temperatures, humidity, location, and the proximity of the user to the computing platform. Individual set points of the user's energy budget may be established (in aggregate total as well as for each specific component of energy consumption) in the remote sensor database and are used in comparison to actual to trigger signals to the GUX for visual metaphor state.

Using the flower garden metaphor, information indicating the user's energy consumption as compare to a budget may be used to indicate one or more flowers as blooming, slightly wilting, wilting and dead, etc. This specific GUX metaphor is only one example of what could be used. The general case is supported by the underlying data model that established values for each of the monitored energy sinks, energy budget set points, and administrative tools that regulate set points.

Currently, energy accounting dashboards present a view from a centralized perspective: a roll-up of the energy consumption of the entire building, or of the major sub-components of building energy consumption. The techniques described herein provide a different perspective that may isolate and report to the individual, their personal energy consumption. By sensing and accounting for each individual's energy consumption, the total energy consumption of all building occupants can be aggregated. Further, the aggregate view provided as described herein may be more accurate by providing a finer grained detail.

The GUX uses a visual metaphor to personalize the accounting of energy consumption. The GUX presents the individual user with a holistic accounting that may be split into major individual components of energy being consumed by their activities and behavior within a larger setting (e.g., building). Thus, the GUX provides an indication of a user's individual energy consumption.

The examples provided herein a generally focused on energy usage, however the concepts and techniques described herein can be applied to general notion of “personal footprint in a sustainable world” keeping track of water, print/copy paper use, recycle/waste generation, just to name a few.

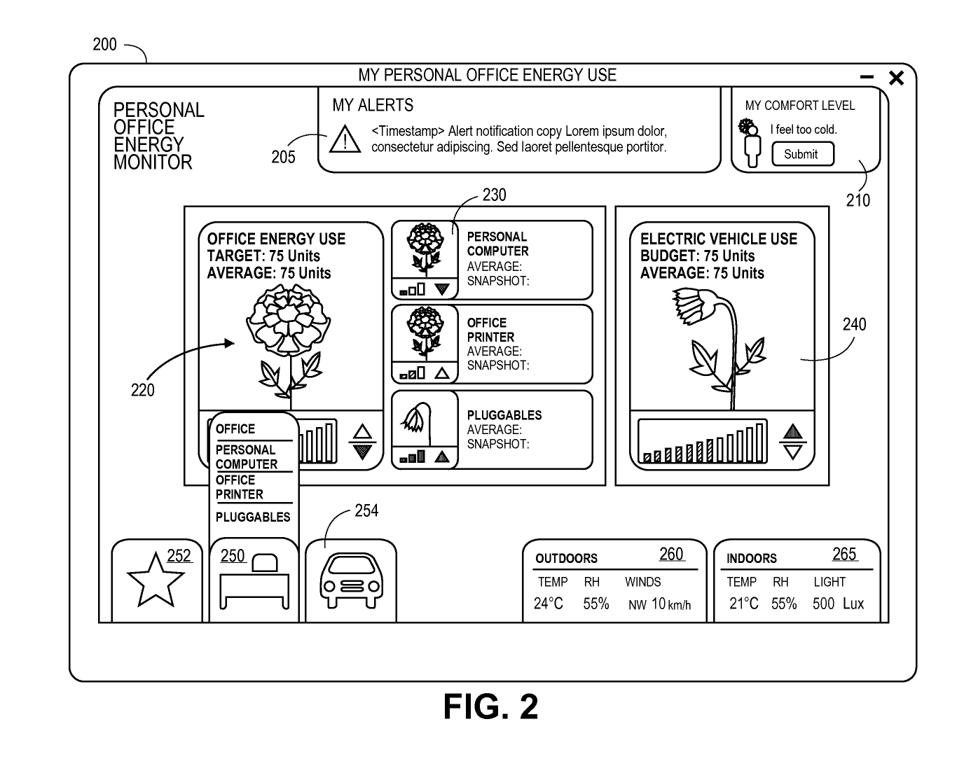

FIG. 2 is one embodiment of a graphical interface for presenting individual energy consumption. The example of FIG. 2 provides flowers as visual metaphors; however, any visual metaphor may be used. Other possible visual metaphors include, for example, trees, skylines, grass, graphs, etc.

Graphical user experience (GUX) 200 includes multiple windows or boxes to provide feedback to a user. In one embodiment, GUX 200 includes alert box 205 that may be used to provide messages to a user. Alerts may be, for example, energy consumption feedback, or other news or feedback. This information may come from a building management system, for example. Comfort level box 210 allows a user to provide feedback regarding the comfort level of his/her space. For example the use may indicate that the temperature or lighting level is uncomfortable. This information may be provided to a building management system, for example. Thus, GUX 200 provides a two-way communication channel between the user and the building management system.

GUX 200 may also provide environmental feedback. For example, outdoor conditions 260 may be displayed and/or indoor conditions 265 may be displayed. Navigation tabs 250, 252 and 254 may allow the user to access other energy consumption information.

In one embodiment, GUX 200 includes multiple visual metaphors corresponding to different aspects of energy consumption by the user. Visual metaphor 220 provides an overall office energy usage for a user. This may correspond to all energy consumption allocated for the office of the user including, for example, a computer, electronic devices powered by outlets in the office, a printer, etc. For a shared printer, the portion of the printer's energy usage allocated to the user may be included.

More specific visual metaphors 230 may be provided for individual devices within the office or associated with the user. For example, a visual metaphor may be provided for a computer, a printer, and devices that are powered by outlets within the office (plugables). In one embodiment, other devices, for example, an electric vehicle may also have a visual metaphor that is provided to the user.

These visual metaphors provide feedback to the user regarding their energy consumption. This feedback may be based on comparisons with other users, budgets set by an administrator, and/or goals or budgets set by the user. The visual metaphor provides an easy and intuitive method for a user to evaluate personal energy consumption.

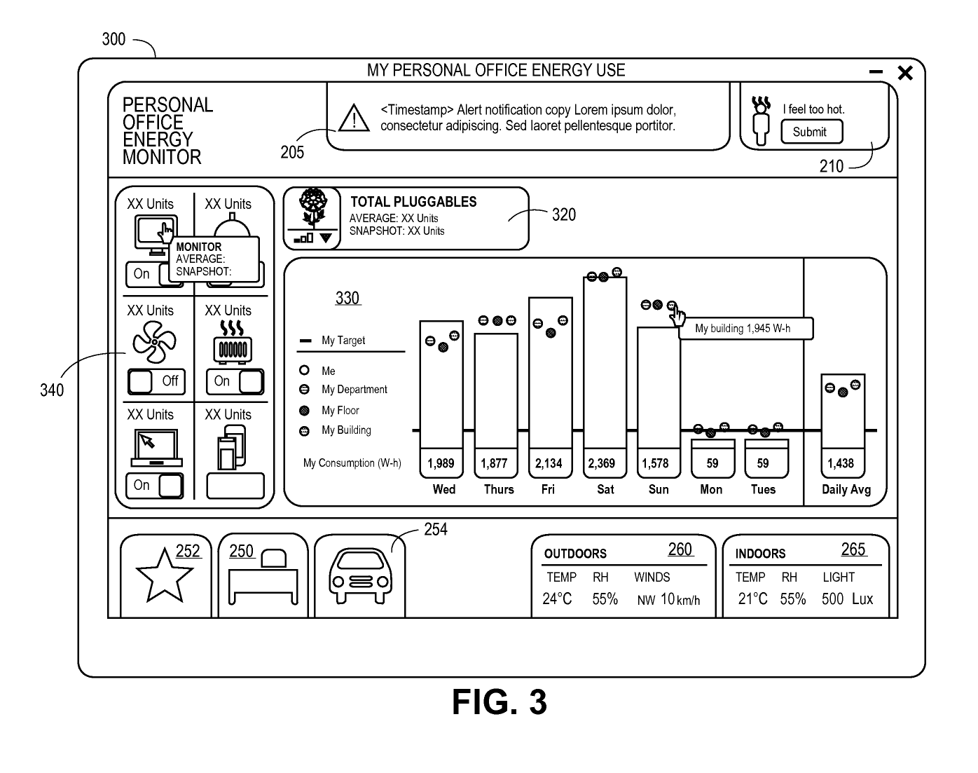

FIG. 3 is one embodiment of a graphical interface for presenting individual energy consumption. The example of FIG. 3 provides flowers as visual metaphors; however, any visual metaphor may be used. Other possible visual metaphors include, for example, trees, skylines, grass, graphs, etc.

In one embodiment, the GUX may be organized as three horizontal regions (top, middle and bottom). In the examples of FIGS. 2 and 3, the top and bottom region are identical, and the middle region changes to relate different information. Other organizations and presentation techniques may also be supported.

GUX 300 provides additional feedback on one of the elements illustrated in FIG. 2. In the example of FIG. 3, additional information may be provided for the plugables indicated in FIG. 3. In one embodiment, GUX 300 provides status information and/or automation functionality, 340, for electronic devices corresponding to the user. For example, fans, heaters, personal electronic devices, etc.

Detailed information window 330 may provide additional, more detailed information than was available in GUX 200 of FIG. 2. For example, a user may be provided with indications of personal energy consumption as compared to a target as well as group information (e.g., department, floor, building). The detailed information may be numerical, graphical and/or a visual metaphor. The user may be provided with historical information as well as projected information.

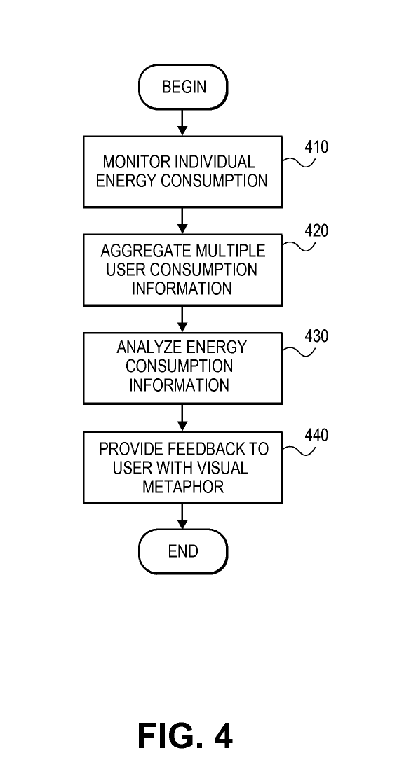

FIG. 4 is a flow diagram of one embodiment of a technique for monitoring and/or presenting individual energy consumption. In one embodiment, the user is provided feedback with a visual metaphor as discussed above. Any type of visual metaphor may be used. The process of FIG. 4 may be performed continuously, periodically and/or it may be event driven (e.g., when energy consumption of a device changes, a location changes, user request, etc.).

Individual energy consumption is monitored, 410. This may be accomplished using any monitoring techniques, including, but not limited to hardware power monitors, software monitoring and extrapolation/interpretation, testing, etc. The individual energy consumption may be for one or more devices including, for example, a computer, lighting, heating/cooling, power outlets, etc. For example, all power consumed within an office may be allocated to an occupant of that office.

Energy consumption for multiple users is aggregated, 420. In one embodiment, a power management server may be coupled to multiple devices for which power consumption is monitored. The power management server may provide analysis and feedback utilizing the aggregated information. Further, the power management server may provide individualized and/or specialized power consumption information for users.

The energy consumption information is analyzed, 430. This analysis may be, for example, to compare users or groups of users to a budget or to each other. Groups or subgroups may be compared to budgets and/or targets. Individual users may be compared to historical trends. These are a few examples of the type of analysis that may be performed on the energy consumption information.

Feedback is provided to the user with at least a visual metaphor, 440. The visual metaphors discussed above may be utilized. Other visual metaphors may also be used. Additional information, for example as illustrated in FIGS. 2 and 3, may also be provided to the user.

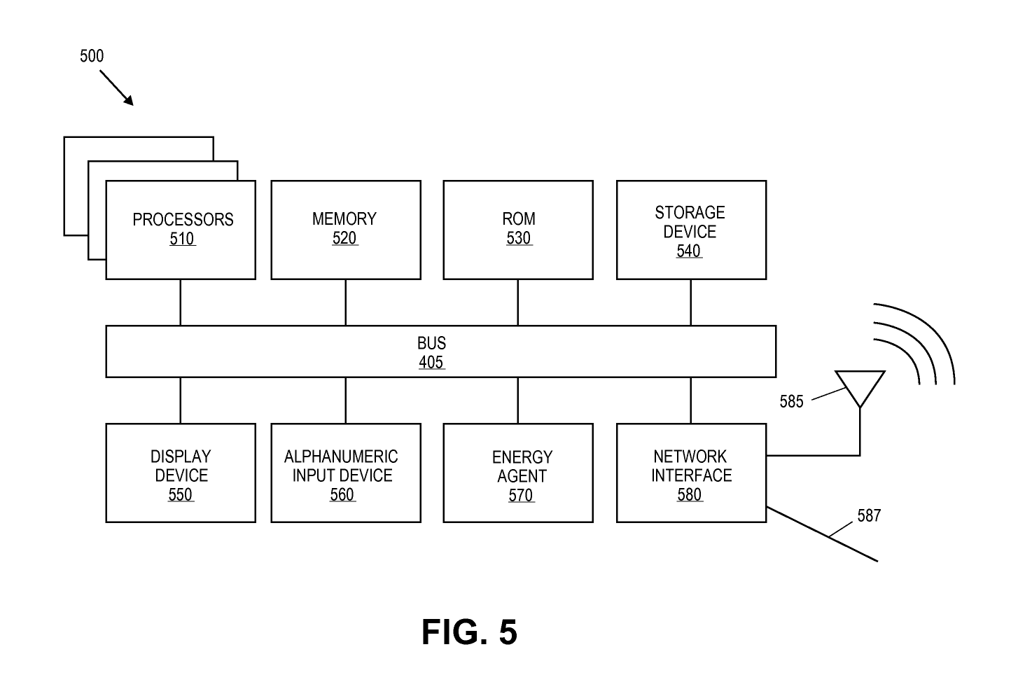

FIG. 5 is a block diagram of one embodiment of an electronic system. The electronic system illustrated in FIG. 5 is intended to represent a range of electronic systems (either wired or wireless) including, for example, desktop computer systems, laptop computer systems, cellular telephones, personal digital assistants (PDAs) including cellular-enabled PDAs, set top boxes. Alternative electronic systems may include more, fewer and/or different components.

Electronic system 500 includes bus 505 or other communication device to communicate information, and processor 510 coupled to bus 505 that may process information. While electronic system 500 is illustrated with a single processor, electronic system 500 may include multiple processors and/or co-processors. Electronic system 500 further may include random access memory (RAM) or other dynamic storage device 520 (referred to as main memory), coupled to bus 505 and may store information and instructions that may be executed by processor 510. Main memory 520 may also be used to store temporary variables or other intermediate information during execution of instructions by processor 510.

Electronic system 500 may also include read only memory (ROM) and/or other static storage device 530 coupled to bus 505 that may store static information and instructions for processor 510. Data storage device 540 may be coupled to bus 505 to store information and instructions. Data storage device 540 such as a magnetic disk or optical disc and corresponding drive may be coupled to electronic system 500.

Electronic system 500 may also be coupled via bus 505 to display device 550, such as a cathode ray tube (CRT) or liquid crystal display (LCD), to display information to a user. Alphanumeric input device 560, including alphanumeric and other keys, may be coupled to bus 505 to communicate information and command selections to processor 510. Another type of user input device may include alphanumeric input 560 may be, for example, a mouse, a trackball, or cursor direction keys to communicate direction information and command selections to processor 510 and to control cursor movement on display 550. In one embodiment, electronic system 500 includes energy agent 570, which may be an energy agent as described herein.

Electronic system 500 further may include network interface(s) 580 to provide access to a network, such as a local area network. Network interface(s) 580 may include, for example, a wireless network interface having antenna 585, which may represent one or more antenna(e). Network interface(s) 580 may also include, for example, a wired network interface to communicate with remote devices via network cable 587, which may be, for example, an Ethernet cable, a coaxial cable, a fiber optic cable, a serial cable, or a parallel cable.

In one embodiment, network interface(s) 580 may provide access to a local area network, for example, by conforming to IEEE 802.11b and/or IEEE 802.11g standards, and/or the wireless network interface may provide access to a personal area network, for example, by conforming to Bluetooth standards. Other wireless network interfaces and/or protocols can also be supported.

IEEE 802.11b corresponds to IEEE Std. 802.11b-1999 entitled “Local and Metropolitan Area Networks, Part 11: Wireless LAN Medium Access Control (MAC) and Physical Layer (PHY) Specifications: Higher-Speed Physical Layer Extension in the 2.4 GHz Band,” approved Sep. 16, 1999 as well as related documents. IEEE 802.11g corresponds to IEEE Std. 802.11g-2003 entitled “Local and Metropolitan Area Networks, Part 11: Wireless LAN Medium Access Control (MAC) and Physical Layer (PHY) Specifications, Amendment 5: Further Higher Rate Extension in the 2.4 GHz Band,” approved Jun. 27, 2003 as well as related documents. Bluetooth protocols are described in “Specification of the Bluetooth System: Core, Version 1.1,” published Feb. 22, 2001 by the Bluetooth Special Interest Group, Inc. Associated as well as previous or subsequent versions of the Bluetooth standard may also be supported.

In addition to, or instead of, communication via wireless LAN standards, network interface(s) 580 may provide wireless communications using, for example, Time Division, Multiple Access (TDMA) protocols, Global System for Mobile Communications (GSM) protocols, Code Division, Multiple Access (CDMA) protocols, and/or any other type of wireless communications protocol.

In one embodiment, the energy consumption information is gathered without the support of a dedicated hardware power meter or sensor. That is, the platform may be self-monitoring and determine its own energy consumption information from monitoring operational states.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A method comprising:
monitoring energy consumption of one or more energy consuming devices corresponding to a user;
aggregating the energy consumption for the one or more energy consuming devices;
providing to the user a graphical representation of the energy consumption for the one or more energy consuming devices and aggregate energy consumption, wherein the graphical representation comprises at least one visual metaphor for energy consumption.

2. The method of claim 1 wherein the one or more energy consuming devices comprise one or more of a computer system, one or more light fixtures, one or more power strips, one or more printing devices.

3. The method of claim 1 wherein aggregating the energy consumption for the one or more energy consuming devices is performed by a server device coupled to receive energy consumption information corresponding to multiple users.

4. The method of claim 1 wherein the visual metaphor comprises an image that is changed according to energy consumption by the user.

5. The method of claim 1 wherein aggregating the energy consumption for the one or more energy consuming devices comprises:
collecting energy consumption information for multiple users in a building;
aggregating the energy consumption information to provide a total energy consumption and energy consumption by device type for the multiple users;
providing sub-group energy consumption information for a subset of the multiple users.

6. The method of claim 5 further comprising providing to the user energy consumption information for the multiple users and for the subset of the multiple users.

7. The method of claim 6 further comprising applying the visual metaphor to the energy consumption information for the multiple users and for the subset of the multiple users.

8. A computer-readable medium having stored thereon instructions that, when executed, cause one or more processors to:
monitor energy consumption of one or more energy consuming devices corresponding to a user;
aggregate the energy consumption for the one or more energy consuming devices;
provide to the user a graphical representation of the energy consumption for the one or more energy consuming devices and aggregate energy consumption, wherein the graphical representation comprises at least one visual metaphor for energy consumption.

9. The computer-readable medium of claim 8 wherein the one or more energy consuming devices comprise one or more of a computer system, one or more light fixtures, one or more power strips, one or more printing devices.

10. The computer-readable medium of claim 8 wherein aggregating the energy consumption for the one or more energy consuming devices is performed by a server device coupled to receive energy consumption information corresponding to multiple users.

11. The computer-readable medium of claim 8 wherein the visual metaphor comprises an image that is changed according to energy consumption by the user.

12. The computer-readable medium of claim 8 wherein the instructions that cause the one or more processors to aggregate the energy consumption for the one or more energy consuming devices comprise instructions that, when executed, cause the one or more processors to:
collect energy consumption information for multiple users in a building;
aggregate the energy consumption information to provide a total energy consumption and energy consumption by device type for the multiple users;
provide sub-group energy consumption information for a subset of the multiple users.

13. The computer-readable medium of claim 12 further comprising instructions that, when executed, cause the one or more processors to provide to the user energy consumption information for the multiple users and for the subset of the multiple users.

14. The computer-readable medium of claim 13 further comprising instructions that, when executed, cause the one or more processors to apply the visual metaphor to the energy consumption information for the multiple users and for the subset of the multiple users.
